(19) United States
(12) Patent Application Publication
(10) Pub. No.: US 2017/0011541 A1
(43) Pub. Date: Jan. 12, 2017

(54) METHOD FOR CREATING ANIMATED ADVERTISEMENTS USING PARALLAX SCROLLING

(71) Applicant: Shahar NAOR, Tel Aviv (IL)

(72) Inventor: Shahar NAOR, Tel Aviv (IL)

(21) Appl. No.: 14/794,942

(22) Filed: Jul. 9, 2015

(51) Int. Cl. G06T 13/20; G06Q 30/02; G09G 5/34; G06F 17/22; G06T 15/20; G06F 3/041

(52) U.S. Cl. CPC G06T 13/20; G06T 15/20; G06F 3/041; G09G 5/34; G06F 17/2247; G06Q 30/0255; G06Q 30/0273; G06T 2200/08

(57) ABSTRACT

A method of creating animated content, which includes the steps of generating an element to be displayed on a mobile device, touch screen or desktop screen. The element includes details of at least one graphical resource together with the settings associated with the graphical resource. The method further includes the steps of adding scrolling and parallax-animation functionality to the generated element and generating computer code to create a parallax-animated display of the created content on the device.

### CROSS REFERENCE TO RELATED APPLICATIONS

This application claims the benefit of U.S. provisional patent application No. 62/022,717 filed on 10 Jul. 2014 and incorporated by reference as if set forth herein.

### FIELD AND BACKGROUND OF INVENTION

The present invention generally relates to the field of animated advertisements and other content. More particularly, the present invention relates to creating and displaying parallax animated advertisements and other type of publications inside an HTML element.

Mobile devices and other devices using touch screens can be configured to respond to a user's touch input. Commonly today, a scrolling function allows the touch screen to respond to a detected user's touch, such as by the user ‘dragging’ the screen in different directions. It is also known to provide User Interfaces (UI) by detecting user touches. For example, US Application No: 2014/0137032 describes a mobile device having a parallax scrolling function.

### SUMMARY OF INVENTION

The present invention relates to a method of creating animated advertisements (ads), user guides, content recommendations or any other type of publications displayed inside another object, such as a website, app or any other supported product, which may be displayed on mobile devices or other devices that use touch screens. The animated content, advertisements, guides or other publications use parallax scrolling (hereinafter referred to as animated parallax publications) and may be created using designated tools and a connecting script. The present invention also relates to measuring and analyzing the performance of the parallax animated publication using a new Key Performance Indicator (KPI)—Cost Per Duration (CPD)—that may track the time viewers spent viewing the ad or publication.

The parallax-animated publications use basic animation with HTML and PNG/JPG and other supported files, placed in layers. The parallax animation may be created by moving the different layers at different speeds in relation to the internet page that displays them and in relation to the layers themselves. The layers may be animated by the viewer as he/she scrolls a page.

Users such as publishers, advertising agencies and designers will be able to upload a design into the designated tool, in layers, and the tool will transform these layers into dynamic variables. The script may use these variables to generate an automated code—creating a scrollable parallax animated publication. Publishers and Ad Networks may then embed the code on the relevant web page, app, or any other supported product.

The advertisers, clients and/or publishers may also track or analyze the CPD performance of the publication. The more common KPIs like CPA (Cost Per Action) and CPM (Cost Per Mille) may also be tracked.

An advantage of the method of the present invention is that enables a larger space to be used than the actual space allocated by the publisher. The publication's different layers may be scrolled, at various speeds within the publication itself, as the viewer scrolls inside a page or a screen.

The tool generates a new creative way to tell a story through an ad, a user guide or any other publication, using non-intrusive animation. The tool also creates a very strong eye-hand connection that makes the content recommendations, advertisement or publication very hard to ignore on the viewer's side.

Furthermore, the tool generates a new measurable KPI that may help publishers, advertisers and other clients adjust their content recommendations, advertisements and other publications and fit them to public demand and better performance.

There is thus provided a method for creating animated content using parallax scrolling. The method includes the steps of: of generating an element to be displayed on a mobile device, touch screen or desktop screen, the element including details of at least one graphical resource together with the settings associated with the graphical resource; adding scrolling and parallax animation functionality to the generated element and generating computer code to create a parallax animated display of the created content on the device.

Furthermore, in accordance with an embodiment of the invention, the method further includes the step of tracking and analyzing the parallax animated display.

Furthermore, in accordance with an embodiment of the invention, the step of generating includes the step of translating at least one graphical resource together with the settings associated with said least one graphical resource into a readable JavaScript® file.

Furthermore, in accordance with an embodiment of the invention, the device includes one of a group of devices including mobile devices, touch screens and desktop computers screens.

Furthermore, in accordance with an embodiment of the invention, the content comprises one of a group including HTML content recommendations, advertisements, user guides and other publications.

Furthermore, in accordance with an embodiment of the invention, the parallax animated publication is generated automatically or manually.

Furthermore, in accordance with an embodiment of the invention, the graphical resource is configured to move at different speeds within the fixed size element containing said graphical resource, in relation to the content surrounding the element inside an HTML page displayed on the device, and in relation to other graphical resources within the element.

Furthermore, in accordance with an embodiment of the invention, the element may include a plurality of graphical resources creating a plurality of layers, each of the layers being configured to move at different speeds. The element having a fixed size is inside an HTML page displayed on the device. The speed is determined either by the user or automatically by the designated tool.

Furthermore, in accordance with an embodiment of the invention, the settings include at least one of a group including the desired resolution, the dimensions of each graphic resource, the speed and offsets of said content and the background image and color.

Furthermore, in accordance with an embodiment of the invention, the method further includes the step of adding onClick action to the generated file.

Furthermore, in accordance with an embodiment of the invention, the method includes the step of outputting an element containing at least one of a group project name, ID/class of main container, graphical resources paths and names, resolutions and graphical resources dimensions, and may include animation template settings.

Furthermore, in accordance with an embodiment of the invention, the step of tracking includes steps of raising a first flag when the first pixel of the element enters the viewport; raising a second flag when the last pixel of the element exits the viewport; and determining the duration of the content inside the viewport display by calculating the delta between the timestamp of the first and second flags.

Furthermore, in accordance with an embodiment of the invention, if the user navigates away while said content is still on the viewport, the step of tracking includes steps of raising a third flag and determining the duration of the content inside the viewport display by calculating the delta between the timestamp of the first and third flags.

### BRIEF DESCRIPTION OF THE DRAWINGS

The present invention will be understood and appreciated more fully from the following description taken in conjunction with the appended drawings in which:

FIG. 1 is a schematic flow chart illustration for automatically creating and generating a single image parallax animated publication, constructed and operative in accordance an embodiment of the invention;

FIG. 2 is a schematic flow chart illustration for automatically creating and generating multiple image parallax animated publication, constructed and operative in accordance an embodiment of the invention;

FIG. 3 is a schematic flow chart illustration for manually creating multiple image parallax animated publication, constructed and operative in accordance an embodiment of the invention;

FIG. 4 is a schematic flow chart illustration for creating a parallax animated publication element on a viewer's device, constructed and operative in accordance an embodiment of the invention;

FIG. 5 shows the effects of speed and size inside a parallax animated publication element consisting of a single graphical resource, created and generated in accordance an embodiment of the invention, within a fixed size element displayed on a mobile device; and

FIG. 6 is a schematic illustration of a generated parallax animated publication on a mobile device, showing the effect of movement of the parallax animated publication consisting of multiple layers within a web page.

### DESCRIPTION OF THE INVENTION

The present invention provides a method of creating parallax animated advertisements (ads), content recommendations, user guides and other publications inside a website, an app or other supported product, which is displayable on mobile devices or other supported devices. The publications may also be tracked and analyzed by the designated tool, the advertiser, publisher or other client.

In an embodiment of the invention, the parallax animated publication may be created using the following resources:

A) A designated tool having multiple modes, as follows (for example):

1. Automated mode, using a single graphical resource (image file, png, jpg or other)—which translates the file and the file's settings into a readable JavaScript® file.

2. Automated mode, using multiple graphical resources (image files, png, jpg or others)—which translates the files and the file's settings into a readable JavaScript® file.

3. Custom (manual) mode, using multiple graphical resources (image files, png, jpg or others)—which translates the files and the file's settings into a readable JavaScript® file.

B) A script adds scrolling and parallax animation to the JavaScript® file generated by the tool (A), and generates the html code required to create the complete parallax animated publication element to be displayed on the mobile screen or any other device.

C) The designated tool may present analytical data of the parallax-animated publication once it is embedded on a web page, app, or other supported product.

D) The designated tool may export the analytical data of the parallax-animated publication once it is embedded on a web page, app, or other supported product to other external sources.

### Generating Dynamic Content

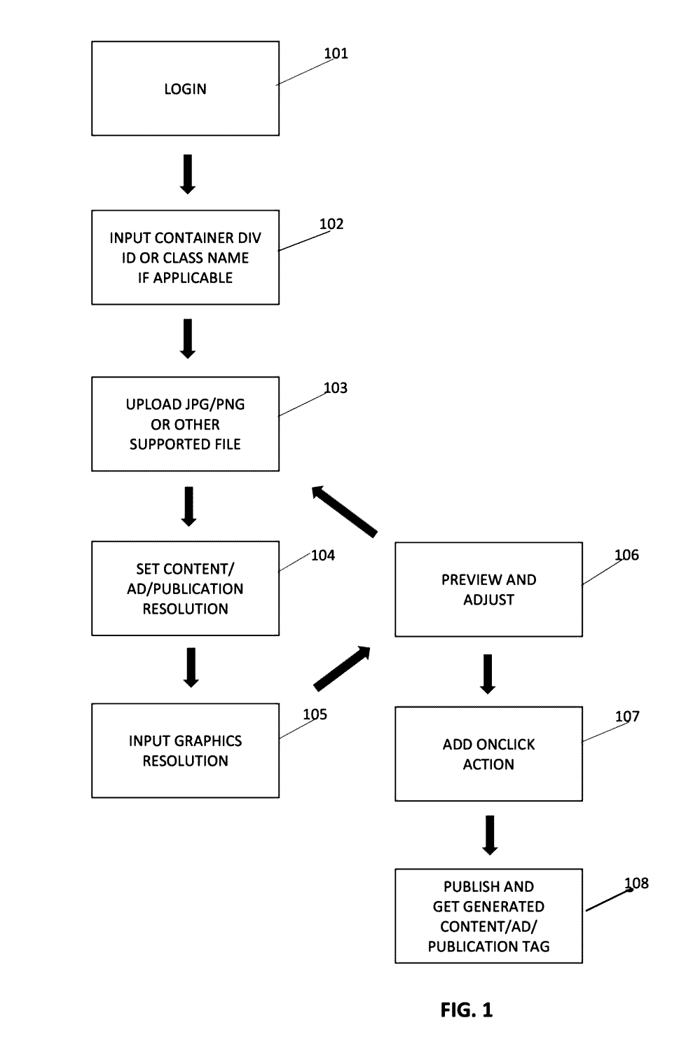

Reference is now made to FIG. 1, which is a flow chart illustration of A1 (Automated mode, using a single graphical resource) which is a dynamic mode for translating a publisher's/advertiser's/client's file and settings into a readable JavaScript®.

### Using the Tool:

The publisher/advertiser/client logs in to the tool (step 101), and inputs their credentials and the project's identifier. If the intended website or publication that will contain the content (or advertisement or publication) consists of elements that stay fixed, the publisher/advertiser/client may enter the specific ID or class name of the main container element of the website/publication (step 102). Then the publisher/advertiser/client uploads their graphic resource, such as png/jpg or other supported format (step 103), selects the desired resolution (step 104) of the ad/publication, inputs the dimensions of the graphic resource (step 105) and after previewing and making any adjustments (step 106) may add “onClick” action (step 107) and publish the project (step 108).

### Output:

The tool generates an output (step 108) of a JavaScript® file containing the elements the user entered, such as project name, ID/class of main container, image paths and names, resolutions and graphic resource dimensions, for example.

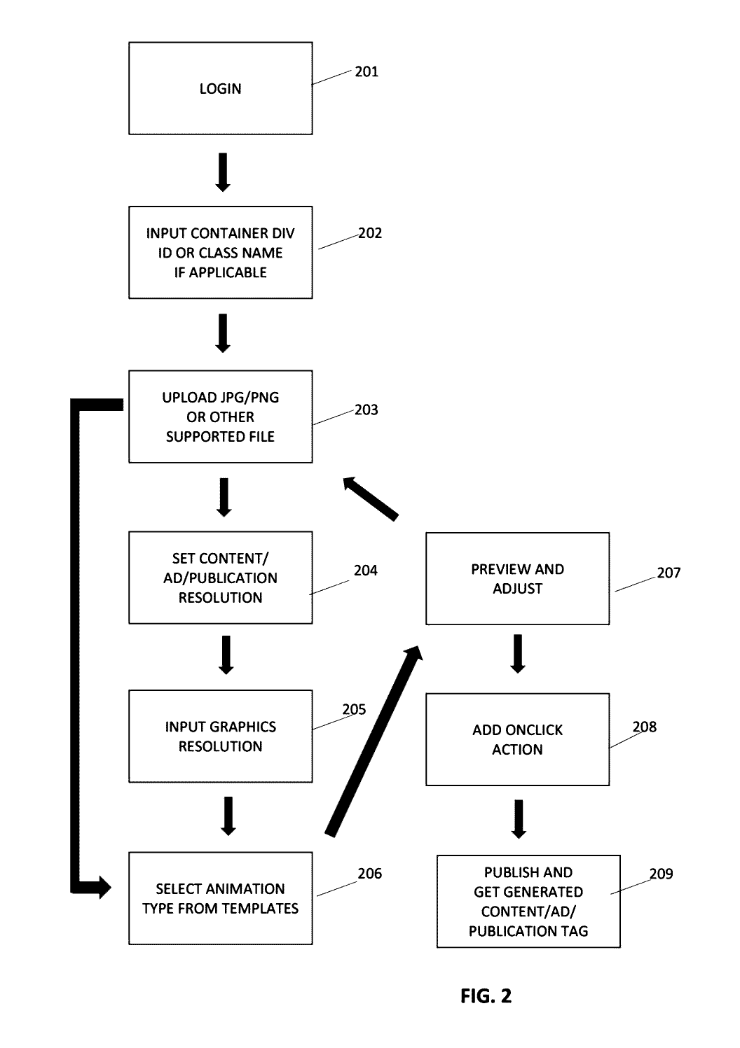

Reference is now made to FIG. 2, which is a flow chart illustration of A2 (Automated mode, using a multiple graphical resources) which is a dynamic mode for translating a publisher's/advertiser's/client's files and settings into a readable JavaScript®.

### Using the Tool:

The publisher/advertiser/client logs in to the tool (step 201), and inputs his credentials and the project's identifier. If the intended website or publication that will contain the parallax-animated publication consists of elements that stay fixed, the publisher/advertiser/client may enter the specific ID or class name of the main container element of the website/publication (step 202).

Then the publisher/advertiser/client uploads their graphic resources—pngs/jpgs or other supported formats (step 203) and selects the desired resolution (step 204) of the ad/publication. The publisher/advertiser/client inputs the dimensions of the graphic resources (step 205), select one of the animation templates the designated tool offers (step 206) and after previewing and making any adjustments (step 207) may add “onClick” actions (step 208) and publish the project (step 209).

### Output:

The tool generates an output (step 209) of a JavaScript® file containing the elements the user entered, such as project name, ID/class of main container, image paths and names, resolutions, graphic resources dimensions and animation template settings, for example.

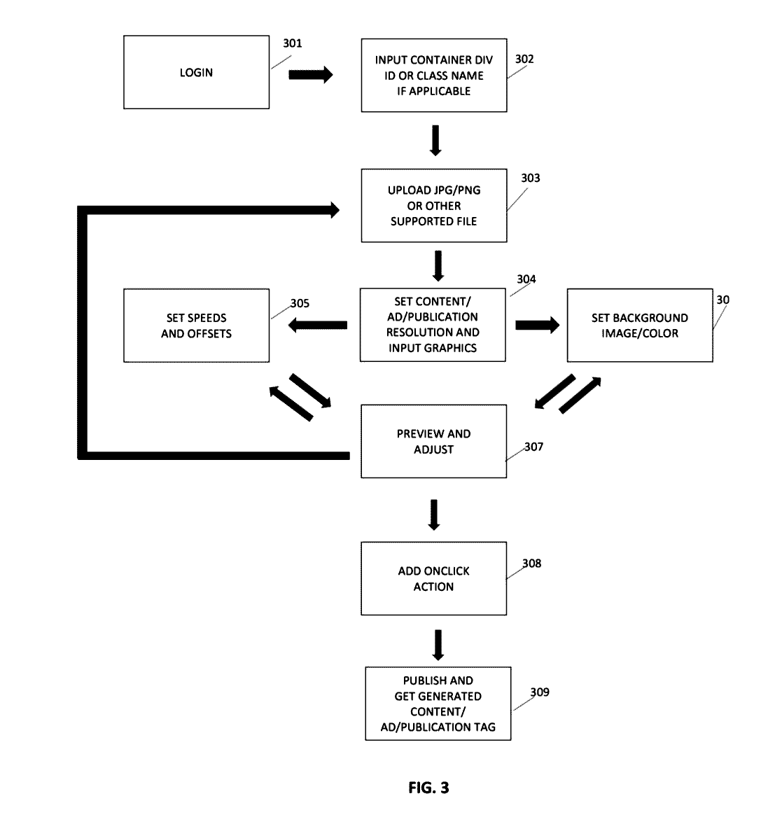

Reference is now made to FIG. 3, which is a flow chart illustration of A3 (Custom or Manual mode, using multiple graphical resources) which is a dynamic mode for translating a publisher's/advertiser's/client's files and settings into a readable JavaScript®.

### Using the Tool:

The publisher/advertiser/client logs in to the tool (step 301), and inputs his credentials and the project's identifier. If the intended website or publication that will contain the parallax-animated publication consists of elements that stay fixed, the publisher/advertiser/client may enter the specific ID or class name of the main container element of the website/publication (step 302). Then the publisher/advertiser/client uploads the graphic resources, such as pngs/jpgs or other supported formats (step 303), selects the desired resolution of the ad/publication, and inputs the dimensions of the graphic resources (step 304).

The publisher/advertiser/client may also select each resource's speed and offset (step 305), as well as the background color (step 306) for the ad/publication.

After previewing and making any adjustments (step 307), the publisher/advertiser/client may add “onClick” actions (step 308) and publish the project (step 309).

### Output:

The tool generates an output (step 309) of a JavaScript® file containing the elements the user entered, such as project name, ID/class of main container, image paths and names, resolutions, graphic resources dimensions and custom animation speeds and offsets settings, for example.

### Generating Parallax Animated Advertisement/Publication on Viewer's Device:

The owner of the target website, app, or other supported product may implement a script or advertisement tag that dynamically generates the parallax-animated publication. The script or advertisement tag may implement three JavaScript® files, for example, one for each of these actions:

1. Supporting functions JavaScript® libraries (JQUERY for desktop devices, ZEPTO for mobile devices)

2. Generated advertisement/publication settings and details (as described in A—see para [0033]);

3. Script for parallax animation and scrolling and their connection to the generated settings and details (as described in B—see para [0034]).

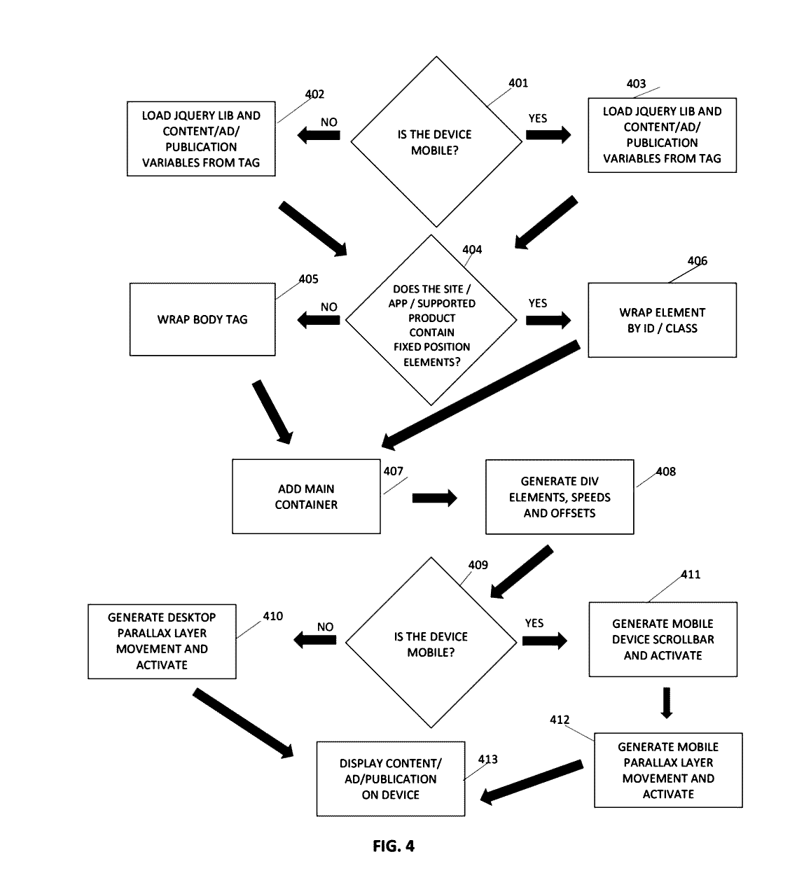

Reference is now made to FIG. 4, which is a flow chart illustration for creating an animated advertisement on a viewer's device, constructed and operative in accordance an embodiment of the invention. FIG. 4 is a flow chart illustration of B (see para [0034] (generating html code) which is a dynamic mode for combining scripts for scrolling and parallax animation with the generated JavaScript® file (A—see para [0033]); to create a parallax animated publication element to be displayed on the viewer's mobile screen or other device.

The script or advertisement tag checks (query box 401) whether the viewer's device is a mobile device (or other supported touch screen device or a desktop device). If the device is a touch screen enabled device, the ZEPTO supporting library is loaded (step 403). If it is a desktop device (not a touch screen enabled device), the JQUERY supporting library is loaded (step 402).

The script or advertisement tag then loads the other scripts (A and B). If the generated settings include a main container (query box 404), indicated by a definition of an element in the settings, that element is wrapped by an HTML div (step 406). If there is not a definition of an element in the settings, whatever is under the target <body> tag is wrapped by an HTML div (step 405).

The wrapped element is then wrapped again, to generate the main container of the website/app/publication (step 407). The scripts then generates all the html code in accordance to the details in the settings (step 408), and checks again for a mobile/touch screen enhanced device (query box 409).

If the check is positive a mobile scrollbar is generated (step 411) and the mobile, parallax effects are activated (step 412). If the check is negative, desktop parallax effects are activated (step 410). Once every other action finishes, the final parallax animated publication is presented on the viewer's device (step 413).

### EXAMPLES

Since parallax animation may cause some layers to move faster than others, the faster moving layers can be longer in length and hold more content. The content/advertisement/publication length is not constrained by the size of the element containing said ad/publication, but by the height of the device/website/app/other product. This allows publishers/advertisers/clients to incorporate more messages into a small space, while at the same time producing a new creative story-telling venue for designers.

FIG. 5 shows the effects of speed of a parallax animated publication element consisting of a single graphical resource, created and generated in accordance an embodiment of the invention, within a fixed size element displayed on a mobile device;

In layer 1, the publication's element allocated resolution is 300×250 pixels, having a background that moves at a regular scroll speed. If the same layer is set to move at double speed, the double speed layer may be up to 300×500 pixels in length (layer 2—FIG. 5). Similarly, if the speed is set to treble speed, the layer may be up to 300×750 pixels in length (layer 3—FIG. 5).

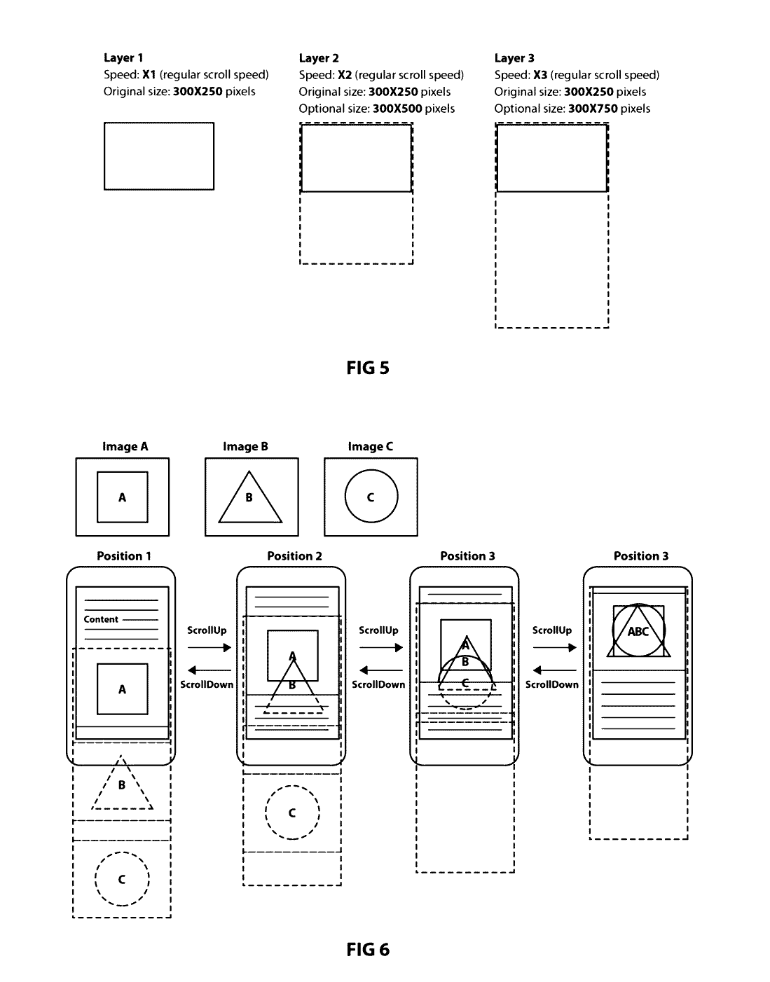

FIG. 6 is a schematic illustration of a generated parallax animated publication inside a webpage element, displayed on a mobile device—showing the effect of movement on an element consisting of multiple layers. In this example, images A, B and C (the graphical resources) combine to create parallax animated content. Content that is positioned outside the viewport is shown as dotted lines.

In this example, Image A is anchored to the content surrounding it, and moves at the same speed with the scrolling of the content like any other static image would. Images B and C have faster speeds defined, so they will scroll faster than the rest of the content.

Positions 1-4 demonstrate a standard scroll action within a touch screen. Inside the parallax animated content element, Image A moves at a regular scroll speed—the same speed of the content surrounding the element. Image B moves faster than Image A, and starts entering the viewport, as shown in position 2. Image C moves faster than Image B, but since its starting position (shown at position 1) is further down, it only starts entering the viewport in position 3. In position 4, all elements are displayed, one on top of the other. Scrolling up or down causes various images to move back and forth, in accordance with their perspective speeds.

### Analyzing the Content—Key Performance Indicator (KPI) Cost Per Duration (CPD):

Since the user scrolls up and down to view the content, which causes the various images of the parallax animated publication to move back and forth, the inventor has realized that the time viewers spent viewing the ad or publication may be tracked. Thus, it is possible advertisers, clients and/or publishers to track and analyze using a new Key Performance Indicator (KPI), herein referred to as the Cost Per Duration (CPD).

The script containing the scroll may track the element holding the parallax animated publication. Once the first pixel of the element enters the viewport, a flag may be raised on the script. Once the last pixel of the element leaves the viewport, a second flag may be raised. If the user navigates away from the HTML containing the parallax -animated publication while the content is still on the viewport, a third flag may be raised. Duration of the content inside the viewport display may be calculated by the delta of the first two flags' timestamp, or by the delta of the first flag and the timestamp third flag.

It will be appreciated that the present invention is not limited by what has been described hereinabove and that numerous modifications, all of which fall within the scope of the present invention, exist. Rather the scope of the invention is defined by the claims, which follow:

1. A method of creating animated content, the method comprising the steps of:
generating an element to be displayed on a device; said element comprising details of at least one graphical resource together with the settings associated with said least one graphical resource;
adding scrolling and parallax animation functionality to said generated element;
generating computer code thereby to create a parallax animated display of the created content on said device.

2. The method of claim 1, further comprising the step of:
tracking and analyzing said parallax animated display.

3. The method of claim 1, wherein said the step of generating comprises the step of:
translating said at least one graphical resource together with the settings associated with said least one graphical resource into a readable JavaScript® file.

4. The method of claim 1, wherein said device comprises one of group of devices including mobile devices, touch screens and desktop computer screens.

5. The method of claim 1, wherein said content comprises one of group including HTML content recommendations, advertisement, user guides and publications.

6. The method of claim 1, wherein said at least one graphical resource is generated automatically or manually.

7. The method of claim 1, wherein said at least one graphical resource is configured to move at different speeds in relation to the content surrounding said at least one graphical resource within said element inside an HTML page displayed on said device, said element having a fixed size.

8. The method of claim 1, wherein said element comprises a plurality of graphical resources generating a plurality of layers, each of said plurality of layers being configured to move at different speeds, said element inside an HTML page displayed on said device, said element having a fixed size, said speed being determined by the length of the layer, animation template or manually.

9. The method of claim 1, wherein said settings comprise at least one of a group including the desired resolution, the dimensions of the graphic resource, the speed and offsets of said content and the background image and color.

10. The method of claim 1, further comprising the step of adding onClick action to said generated file.

11. The method of claim 1, further comprising the step of outputting a file containing at least one of a group project name, ID/class of main container, image paths and names, resolutions and graphic resource dimensions and animation template settings.

12. The method of claim 2, wherein said step of tracking comprises steps of:
raising a first flag when the first pixel of the element enters the viewport;
raising a second flag when the last pixel of the element exits the viewport; and
determining the duration of the content inside the viewport display by calculating the delta between the timestamp of the first and second flags.

13. The method of claim 12, wherein, if the user navigates to a second content while said content is still on the viewport, said step of tracking comprises steps of:
raising a third flag; and
determining the duration of the content inside the viewport display by calculating the delta between the timestamp of the first and third flags.
